(19) United States
(12) Patent Application Publication
(10) Pub. No.: US 2009/0099970 A1
(43) Pub. Date: Apr. 16, 2009

(54) Multivariate Blind Bidding Negotiation Support System Rewarding Smallest Last Session Move

(76) Inventors: Ernest M. Thiessen, Abbotsford (CA); Paul Miniato, Delta (CA)

Correspondence Address: JONES, TULLAR & COOPER, P.C., P.O. BOX 2266 EADS STATION, ARLINGTON, VA, 22202, US

(21) Appl. No.: 12/251,410

(22) Filed: Oct. 14, 2008

Related U.S. Application Data
(60) Provisional application No. 60/979,554, filed on Oct. 12, 2007.

(51) Int. Cl. G06Q 30/00

(52) U.S. Cl. 705/80

(57) ABSTRACT

A multi-issue, multiparty computer-based blind-bidding system and method give an incentive for moving quickly to the zone of agreement. Confidential information is managed by a neutral site. After receiving optimistic proposals from the parties, the system generates visible suggestions, which are potential agreements whose values are derived from party preference information. Parties can see the suggestions generated by the system, but are “blind” to a confidential acceptance that any other party may indicate with respect to any package. Parties negotiate in a series of sessions where parties reach an agreement at the end of a particular session if they have accepted at least one same potential agreement. If parties have mutually accepted more than one same potential agreement by the end of the session, the agreement is determined by an algorithm that favors the party who moved the shortest relative distance during the session that just completed.

### CROSS REFERENCE TO RELATED APPLICATIONS

This application claims the benefit under 35 U.S.C. 11 9(e) of U.S. Provisional Application No. 60/979,554, which was filed on Oct. 12, 2007, and is hereby incorporated by reference in its entirety.

### BACKGROUND OF THE INVENTION

1. Field of the Invention

The present invention relates in general to a computer-based decision support system for multiple parties involved in any type of negotiation. In complex negotiations, the system assists parties in reaching an agreement that optimizes the individual and overall benefit to the parties.

2. Description of the Background Art

Negotiation is a process where two or more parties with conflicting objectives attempt to reach an agreement. This process includes not only bargaining—the presentation and exchange of proposals for addressing particular issues—but also the attempts by each party to discover and use knowledge of the preferences, strengths and weaknesses of their opponents to reach a resolution that maximizes their own objectives while still being acceptable to other parties. Negotiating parties may be individuals or teams representing their own interests or the interests of their organizations. When there is at least some willingness to engage in negotiation, it can be a constructive alternative to other means (e.g., violence, litigation, stalemate) of settling disputes.

Negotiators have several basic tasks, which are non-trivial when many issues (or decision variables) are involved:

| | |
|---|---|
| Qualify Interests | Identify potential agreements that will be acceptable |
| | to all parties. |
| Quantify | Determine how each party would become satisfied |
| Satisfaction | on each of the variables. |
| Establish Equity | Agree on how the benefits should be divided among |
| | the parties. |
| Maximize Benefits | Find an outcome that maximizes the mutual benefits |
| | for the parties. |
| Secure Commitment | Ensure that the agreement will be implemented as |
| | expected. |

In order to accomplish these tasks, negotiators must explore the impacts of various decisions, and at least begin to understand the tradeoffs among these impacts. A third party mediator or facilitator may be included in a negotiation process to help manage the interactions and make suggestions for negotiating parties to consider. Alternatively, an arbitrator may be involved with the power to draft and perhaps dictate settlements for the parties. It is commonly recognized that such disinterested parties can significantly help negotiators in their quest for an agreement.

Recent developments in modeling negotiation processes, more powerful computers, and the maturing of the Internet are motivating work in the use of computer-based analyses and network solutions for complex negotiation problems. State-of-the-art interactive interfaces today permit the updating of issue descriptions, preferences, and interested stakeholders as the negotiation process proceeds.

The current literature on interactive computer programs for multi-objective conflict resolution commonly uses the term Negotiation Support System. This term refers to the special type of group decision support system designed for providing assistance in situations where there is disagreement and conflict among various parties as to what decisions to adopt. Research addressing group decision making in multi-objective situations is in its third decade, yet the development and use of Negotiation Support Systems to facilitate and help guide multi-party negotiations is still considered a relatively new field.

Negotiation Support Systems can be categorized according to their functions either as negotiation preparation systems, supporting a pre-negotiation strategic planning stage, or negotiation information management systems, facilitating negotiations in real time. Negotiation information management systems can be further classified as either context support systems or process support systems. Context models focus on the behavior of the system being designed, managed or operated. Such models are used to answer questions about the performance of the system given any particular decision regarding its design, management or operation. Process models are concerned with the dynamics or procedure of the negotiation process that includes how a group of parties with differing and conflicting objectives can reach an acceptable agreement.

Numerous efforts are underway in each of the various kinds of Negotiation Support Systems described above. Of particular interest here are process support systems. These systems are designed to provide a practical means of increasing the likelihood of mutually agreeable settlements when a potential region of agreement exists. Sometimes they can help identify better solutions than would have been found without their use. The majority of process support systems described in the literature for complex negotiations, are still in the conceptual stage, or, at best, play a relatively passive role in the negotiation process. There are some working systems that are single workstations that support a professional mediator rather than the negotiating parties directly. The one prior art process support system that stands out in its ability to substantially aid negotiating parties in a complex real-world setting is ICANS, as described in U.S. Pat. No. 5,495,412 and presently implemented in Smartsettle (www.smartsettle.com).

There are also some other very simple existing systems for automated univariate blind bidding. Cybersettle and Debt Resolve seem to be the current main contenders. All existing blind bidding systems (other than Smartsettle) have one thing in common, in that they take blind proposals from each party (offers and demands) and split the difference (or the overlap) according to some agreed formula when proposals are close enough (or overlap). These systems have several drawbacks:

If an agreement can result when proposals are only close to each other, e.g., within some percentage like, say, 30%, then there is a documented chilling effect, which inhibits concessions. In this case, parties must also understand the formula that is used for splitting the difference and make an extra calculation before making a proposal in order to determine what they might actually be agreeing to.

Parties must depend on the system to decide on the degree of precision needed for the solution when it splits the difference or splits the overlap.

These systems do not reward large concessions. This results in a relatively slow concession process.

These systems are not conducive to early intervention, thus limiting the potential benefits.

These systems are not interactive.

These systems are not easily scalable to more than one variable or more than two negotiating parties, i.e., for all practical purposes, they are restricted to cases with two parties negotiating one decision variable.

A general problem in negotiations involving multiple issues is finding an optimal agreement in light of complexity and different confidential preferences of the negotiating parties.

### SUMMARY OF THE INVENTION

The subject invention addresses the foregoing shortcomings of known negotiation settlement systems and comprises an improved computer-based interactive blind-bidding system and method for supporting negotiations. The system and method employ an algorithm that provides improved performance over the algorithm disclosed in US Published Patent Application No. 20030163406, published Aug. 28, 2003, which is entitled Blind Bidding Negotiation Support System for any Number of Issues and is hereby incorporated by reference in its entirety (hereinafter referred to as “the '406 application”). In particular and as will be discussed in detail below, the improved algorithm employs multiple negotiation sessions and a technique which encourages the participants to move quickly toward settlement of the negotiation.

As in the system disclosed in the '406 application, variables (including decision variables and performance measures) are identified and modeled with each negotiating party indicating preferred outcomes for each variable. Parties can then create proposals and other potential agreements within those ranges, which may be visible to other parties or not, at their own option. When requested by the parties, the system generates visible potential agreements whose values are derived on the basis of preference information provided by the parties. If some potential agreements already exist, newly generated potential agreements fall between the existing ones in terms of satisfaction levels. In this system, parties can see the potential agreements suggested by the system, but are “blind” to a confidential acceptance that any other party can indicate with respect to any package (set of variable values (including the trivial case of one variable)). Two or more parties reach an agreement when they accept one or more of the same potential agreements.

In general, the disclosed system assists any number of parties involved in simple or complex multivariate negotiations in reaching an agreement that optimizes both the individual and overall benefit to the parties. The parties begin by collaborating in building a Framework for Agreement. The Framework for Agreement may include constraints that relate two or more decision variables. From the Framework for Agreement, a list of decision variables can be derived and entered into a computer system. Each of the parties to a conflict or dispute to be negotiated then enters their own preferences concerning each decision variable into the computer system. They may also enter private variables (e.g. performance measures) and/or private constraints if this provides a better problem description.

If desired, each party to the dispute can have a separate computer system so that each party's preference information remains confidential to that party. The preference information includes data on satisfaction functions for each variable. Each satisfaction function defines a party's relative level of satisfaction as a function of a numerical value for the outcome of that variable. The preference information for each party includes more preferred and less preferred outcomes that define bargaining ranges and a relative importance assigned to each variable with respect to its bargaining range. With bargaining ranges defined, packages can be identified, each such package being a potential agreement. Every package that is created by any party or by the system is associated with a specified level of satisfaction or rating for each party that is determined by the variable satisfaction functions and relative importances. Each party has a private view in which packages are rated according to their own preferences

Parties may create any number of private packages for their own consideration. The system may also generate one or more packages as potential agreements that, in terms of satisfaction levels, fall within bargaining ranges by the parties. In the remainder of this description and in the included illustrations, this type of package is referred to as a Suggestion. To assist a party in evaluating their own preferences, the system may generate one or more packages that are equivalent to other packages, i.e., provide approximately the same level of satisfaction to a party as other packages. Each party may also enter one or more packages that are published as proposed agreements (i.e. for other parties to see). If two or more parties have made proposals or have accepted packages that are close enough to each other (in terms of satisfaction levels), the system may generate another single package that simultaneously satisfies all parties by providing approximately the same level of satisfaction as their current proposals would provide. Parties may accept, in confidence, any package, including any Suggestion generated by the system that is displayed on their private view.

One of the key differences between the present invention and the system and method disclosed in the '406 application is that the negotiation process in the present invention is divided into a series of sessions. Parties may accept any number of packages in a particular session. At the end of a session, if two or more parties have accepted the same package, that package becomes a tentative agreement among those parties. If parties have accepted more than one same package, the system declares one of them to become the tentative agreement using an algorithm that rewards the party that moved the shortest distance during the session. A party's move during a session is measured by calculating the difference in normalized rating of the least preferred accepted packages at the beginning and end of the session.

Packages are generated by the system using optimization techniques, the preferred method using standard mixed-integer linear programming techniques to solve an appropriate optimization problem that takes into account the preference information of the parties and obeys any shared or private constraints that have been defined. “Minimizing the maximum gain” between existing proposals and a generated package is one technique that may be used to generate an equivalent package for two or more parties. Once parties have reached a tentative agreement by any means, parties may elect to have an optimal agreement to the conflict determined, again using linear programming techniques, by “Maximizing the minimum gain” in satisfaction achieved by each of the parties in going from the tentative to an improved package. This will, at the same time, maximize the overall benefit to all of the parties. For maximum security of all party's confidential information, a separate computer system located at a neutral site can be connected to each individual party's computer system. In this case, packages are generated at the neutral site and transmitted back to each party's own computer system. Encryption is used to maintain transmission security. This entire system may be automated in repetitive negotiations in which the computer systems controlled by the parties may derive required input information from simulation models rather than that information having to be explicitly entered each time.

The main advantage of the disclosed system over the previous system in the '406 application is that it provides a process that enables negotiators to reach an agreement more quickly than other methods. An interactive graphical interface that displays Suggestions clearly shows negotiators all potential agreements before an agreement is declared (it does not require any “split-the-difference” formula). The interactive features are also more conducive to early intervention as they allow the formulation of the case to evolve with time as information and circumstances change. The algorithm rewards the smallest last session move and thus encourages parties to start with realistic initial proposals and to make relatively large concessions toward the expected zone of agreement. More particularly, when a session results in hidden acceptance by both parties of a proposed agreement that is acceptable to both parties, the algorithm rewards the party that changed their acceptance by the least amount in the session that resulted in the agreement. The parties are made aware of this feature of the algorithm prior to initiating the negotiation process. As a result, parties tend to move quickly toward an acceptable range of settlement values in the early sessions of the negotiation to avoid having to make big moves in the final session that will benefit the other party or parties to the negotiation. Hidden acceptance blind bidding combined with the fact that the parties know that they will be rewarded for moving quickly in the direction of settling the issues being negotiated is the key to virtually eliminating the traditional tedious negotiation dance in any type of negotiation. By its very nature, multivariate blind bidding, which makes possible comprehensive modeling and is based on the preferences of the negotiators, tends to produce agreements that are closer to optimal than other methods.

### BRIEF DESCRIPTION OF THE DRAWINGS

The objects, features and advantages of the present invention will become more apparent from the following detailed description of a preferred embodiment thereof, taken in conjunction with the accompanying drawings, which are described briefly as follows.

FIG. 1 is a flow chart illustrating the steps that are carried out during use of the method and system of the preferred embodiment of the invention during a negotiation process between two or more parties.

FIG. 2 is a graph illustrating how the algorithm of the preferred embodiment rewards the party to the negotiation that makes the smallest move during a session where a tentative agreement to one or more issues is declared by the algorithm.

### DETAILED DESCRIPTION OF THE PREFERRED EMBODIMENT

### Overview

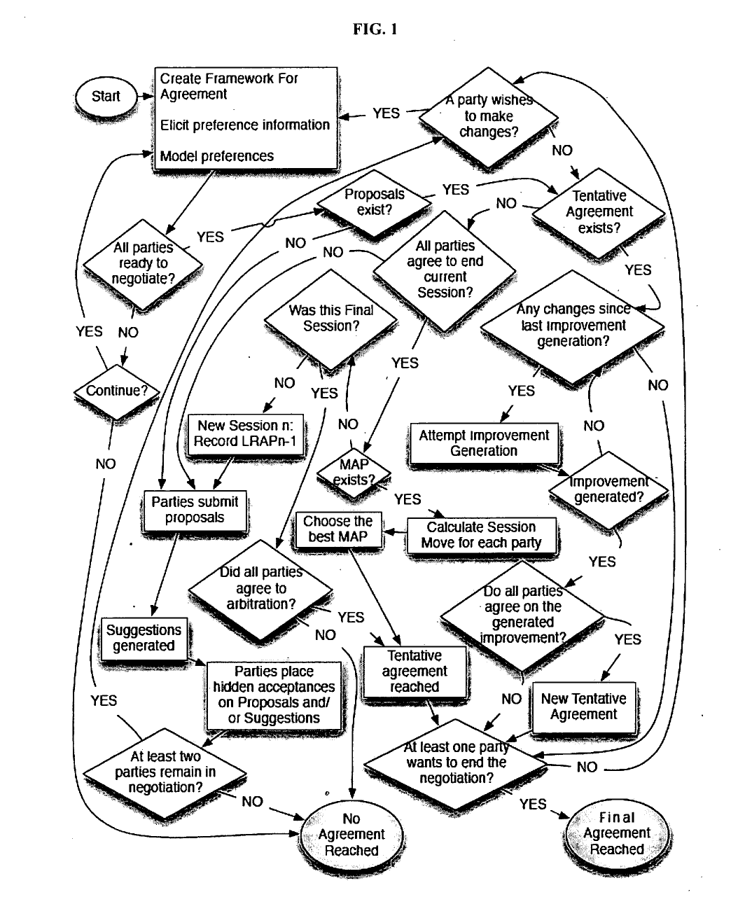

As already noted, the present invention represents an improvement of the invention disclosed in the '406 application. Preferably, the invention employs a computer system such as the one disclosed in FIG. 1 of U.S. Pat. No. 5,495,412, which is also hereby incorporated by reference. The computer system preferably employs multiple independent computers, one for each party to a negotiation and a remote central computer which contains the algorithm of the present invention in its operating memory and executes the algorithm in response to information received from each of the independent computers regarding the parties' desired outcomes and preferences to the negotiation. However, it should be understood that the invention can also be carried out using a single computer system where a neutral party enters the information for the parties to the negotiation to maintain the necessary confidentiality for the blind acceptances feature of the invention disclosed in the '406 application, which is also a feature in the subject invention.

The present invention introduces an algorithm that rewards a strategy of quick concessions in a session process. The new multivariate (or multi-issue) blind bidding method is described here in the wider context of the original multivariate blind bidding method disclosed in the '406 application in order to illustrate the most preferred embodiment of the method and assist the reader to completely understand the invention. However, the reader is advised to also read the '406 application in order to best understand the present invention. The disclosed system and method is planned to be implemented in a new release of Smartsettle at www.smartsettle.com and will be referred to by that name throughout this description.

In general, Smartsettle is implemented on a computer by providing the negotiating parties with an acceptable interactive graphical interface which includes any suitable input and output devices. It assists any number of parties involved in simple or complex negotiations with any number of matters in dispute (issues) in reaching an agreement that quickly produces an optimal agreement, maximizing the joint benefits of all parties.

Smartsettle comes to a negotiating problem as an empty and impartial shell, taking no predetermined prescriptive role. Any final solution is allowed as long as all parties have accepted it. However, the system can help guide parties toward a Pareto optimal agreement, i.e., an agreement in which no party's satisfaction level can be increased without decreasing the satisfaction of at least one other party.

FIG. 1 shows a flowchart illustrating the specific method steps carried out by the entire negotiation process. As with the method disclosed in the '406 application, Smartsettle requires parties to first collaborate in building a Framework for Agreement. The Framework for Agreement is similar to the final agreement, except with blanks representing the issues or decision variables to be negotiated. The Framework for Agreement may include constraints that relate two or more decision variables. From the Framework for Agreement, a list of issues (and related decision variables) can be derived and entered into a computer system.

Each party in the negotiation can have its own individual objectives or goals, which need not be revealed to others and need not be quantified. The degree to which each objective is satisfied will be a function of the negotiated decision values for the issues at stake, and perhaps even on the process of obtaining them. Although the set of issues being considered may change during the negotiation process, it is important that the final set of issues (representing the decisions that must be made) are agreed upon, explicitly defined, understood and accepted by all parties.

After parties have agreed on the representation of their negotiation problem, the system needs to elicit at least a minimum amount of preference information from each party for the purpose of creating mathematical representations of preferred outcomes, private bargaining ranges and satisfaction ratings for potential agreements. Parties may also enter private variables and/or private constraints if this provides a better problem description. Parties are not usually willing to share the details of their private preferences with other parties. Therefore, Smartsettle preferably keeps such information confidential in files contained within the individual computer systems that are accessible only to the party whose information is in those files.

Negotiations begin with each party submitting an optimistic proposal. When revealed, these proposals create shared bargaining ranges. Smartsettle can then generate Suggestions on which parties can place a confidential (i.e. “blind”) acceptance. When parties accept one or more of the same packages Smartsettle declares one of them to be a tentative agreement. In multivariate negotiations, if preferences are well-represented, Smartsettle can use optimization to look for improvements to insure that no value is left on the table.

### Reward For Smallest Last Session Move

The negotiation process is preferably divided into a series of sessions. Parties may accept any number of packages in a particular session. At the end of a session, if two or more parties have accepted the same package, that package becomes a tentative agreement among those parties. If parties have accepted more than one same package, the system declares one of them to become the tentative agreement using an algorithm that rewards the party that moved the shortest distance during the current session. In other words, the party that changes their acceptance the least amount during the session which results in generation of the tentative agreement is rewarded by the algorithm generating a proposed agreement on the variable in question that has a value that is closer to that party's current proposed value. A party's move during a session is measured by calculating the difference in normalized rating of the least preferred accepted packages at the beginning and end of the session.

Each party to the negotiation is made aware of the forgoing characteristic of the algorithm at the start of the negotiation process. This encourages the parties to make bigger concessions on the negotiation variables in the early sessions of the negotiation, so that they will be more likely to be the party that needs to move the least amount and thus gets rewarded by the algorithm during the final negotiation session. In actual tests of the preferred embodiment, the rate of success in settling various negotiation problems using the inventive technique was a remarkable 93%.

### EXAMPLE

As an example of the algorithm employed in the preferred embodiment, consider the general case with multiple decision variables and two or more parties where a number of packages are available as potential agreements, each representing specific values for each variable. At the beginning of a session, parties will each have accepted some packages, but there are no mutually acceptable packages (MAPs). At the end of the session, assume that there are at least two packages acceptable to all parties. The algorithm is designed to select one of these mutually acceptable packages. In the case where there is only one mutually acceptable package at the end of the session, that package becomes the tentative agreement. In the case where there are still no mutually acceptable packages, the negotiations must continue for another session.

For each party, for the session that results in mutually acceptable packages, there will be a “Session Move” that represents how far that party has “moved” during the session. Each party's Session Move is defined as the distance on a normalized rating scale between the party's lowest-rated-accepted package (LRAPₙ₋₁) as of the end of the previous session, and their lowest-rated accepted package (LRAPₙ) at the end of this session.

For each party, there is a potential “benefit” to be split, which is represented by the difference on their normalized rating scale between their lowest-rated and their highest-rated of the mutually acceptable packages.

In the general case, each party gives up a share of the benefit in proportion to their Session Move relative to the sum total of Session Moves over all of the parties. The actual package chosen is the one that is closest to all parties giving up their share of the benefit, without requiring the party with the smallest Session Move to give up more than their share of the benefit.

In the special case where there are only two parties, A and B, and only one issue (variable) that has an assumed linear satisfaction function for each party, the problem reduces such that eligible “packages” are simple numerical values representing possible settlements—mutually acceptable values (MAVs).

Assume:

Mₐ is the Session Move for Party A, Mₐ>=0

M_{b} is the Session Move for Party B, M_{b}>=0

Aₐ is Party A's least preferred of the MAVs p Aₐ is Party B's most preferred of the MAVs (following from the assumption of linear preferences)

A_{b} is Party B's least preferred of the MAVs

A_{b} is Party A's most preferred of the MAVs (following from the assumption of linear preferences)

χ will be the calculated agreement

We have:

The total benefit to be split: (Aₐ−A_{b})

The benefit “given up” by Party A: (χ−A_{b})

The total Session Move, for normalization: (Mₐ+M_{b}), where Mₐ+M_{b}>0

Per the objective: (χ−A_{b})/(Aₐ−A_{b})=Mₐ/(Mₐ+M_{b})

Or: χx=(Mₐ Aₐ+M_{b} A_{b})/(Mₐ+M_{b})

To avoid division by zero, the case where Mₐ and M_{b} are both zero must be treated as a special case. In this case the agreement can be logically calculated as:

χ=(Aₐ+A_{b})/2

This can only happen if neither party moves in the first session and each party's proposal is acceptable to the other party.

As a final step, if the formula yields one of the MAVs exactly, that MAV becomes the agreement. Otherwise, the formula result x is “rounded” to the nearest MAV in the direction that favors the party with the smallest Session Move, or, if both parties moved equally, the party who moved first.

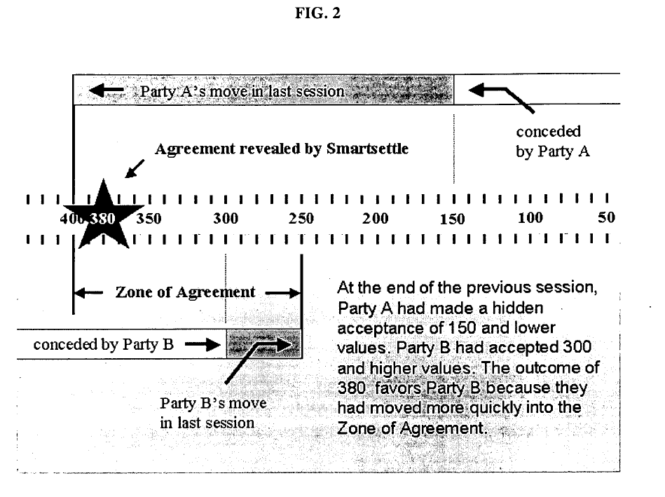

The graph of FIG. 2 illustrates the following example calculation for the special case with two parties, and one issue (variable), with an assumed linear satisfaction function. Assume that at the end of a session, Party A has accepted values up to and including 150. Party B has accepted values down to and including 300. As yet there is no agreement. During the next session, Party A accepts all multiples of 10 up to and including 400, while Party B accepts all multiples of 10 down to and including 250. At the end of this session, the mutually acceptable values are therefore the multiples of 10 from 250 through 400, in other words: 250, 260, 270, . . . , 380,390,400.

Thus:

Mₐ=400−150=250

M_{b}=250−300=50 (smallest Session Move)

Aₐ=400

A_{b}=250

χ=(Mₐ Aₐ+M_{b} A_{b})/(Mₐ+M_{b})

χx=(250*400+50*250)/(250+50)

χ=375

χ=380, rounded to the MAV that favors Party B (the one with the smallest Session Move).

The value of 380 is therefore selected from the list of mutually accepted values to be the tentative agreement.

Although the invention has been disclosed in terms of a preferred embodiment and variations thereon, it will be understood that numerous additional modifications and variations could be made thereto without departing from the scope of the invention as set forth in the following claims.

What is claimed is:

1. A computer system for assisting at least two parties involved in a negotiation problem with any number of issues and associated decision variables toward achieving a mutually satisfactory agreement on decisions to be taken on one or more of said variables, comprising:
a) a processor;
b) an operating memory readable by said processor;
c) an interface for entering data from an input device into said processor and supplying output data generated by said processor to an output device;
d) a program tangibly embodied in said operating memory and executable by said processor to carry out the steps of:
1) receiving preference information from each of said parties pertaining to the outcome of each variable involved in said negotiation problem, said information including at least a first proposal by each of said parties that specifies an outcome of all of the issues to be negotiated;
2) generating a plurality of suggestions which are potential agreements that are supplied to said output device, each of said suggestions including a value for each issue being negotiated, and each of said suggestions being within a range of values defined by the first proposals entered by each of said parties;
3) in response to acceptance of one or more of said suggestions received in confidence from each of said parties and a determination that each of the parties has not agreed to at least one same suggestion, generating an indication on said output device that another session of negotiation is required to settle the negotiation problem;
4) repeating step 3) until each of said parties mutually agrees to at least two of said suggestions, and when so,
5) employing a formula that favors a one of said parties that changed their acceptance the least in the current session to determine and select which of said at least two suggestions represents a tentative agreement to the negotiation; and
6) providing the selected suggestion as output to said output device that represents a tentative agreement to said negotiation problem.

2. The computer system of claim 1, wherein said program generates a new suggestion from a plurality of existing suggestions, one for each of said parties, comprised of potential decisions to be taken on at least one of said variables, each said existing suggestion being acceptable to its corresponding party and providing a specified level of satisfaction for that party, said new suggestion being generated from said plurality of acceptable suggestions and preference information from each party using optimization techniques so that said generated suggestion provides a level of satisfaction to each said party that is at least as great as the level of satisfaction provided by each said party's acceptable suggestion.

3. The computer system of claim 2, wherein said program generates an improved suggestion from said tentative agreement that is Pareto optimal according to said information pertaining to each said party's preferences.

4. The computer system of claim 1, wherein if use of said formula results in a value that is not equal to the values of any of said mutually acceptable suggestions, the program rounds the calculated value to the nearest one of said mutually acceptable suggestions.
